(19) United States
(12) Patent Application Publication
(10) Pub. No.: US 2025/0346136 A1
(43) Pub. Date: Nov. 13, 2025

(54) CHARGING DEVICE

(71) Applicant: LG ELECTRONICS INC., Seoul (KR)

(72) Inventors: Kangsuk LEE, Seoul (KR); Suk KO, Seoul (KR); Sunghwan OH, Seoul (KR); Myoungku LEE, Seoul (KR)

(73) Assignee: LG ELECTRONICS INC., Seoul (KR)

(21) Appl. No.: 18/760,969

(22) Filed: Jul. 1, 2024

(30) Foreign Application Priority Data
May 8, 2024 (WO) PCT/KR2024/006185

(51) Int. Cl. B60L 53/31; H02J 7/00

(52) U.S. Cl. CPC B60L 53/31; H02J 7/0042

(57) ABSTRACT

Disclosed is a charging device including a main body having a cable connected charger located therein, a front door covering a front surface of the main body and some of both side surfaces of the main body, a pair of side covers covering the rest of the both side surfaces of the main body, a rear cover covering a rear surface of the main body, and a locking part located at a top surface of the main body, wherein the top surface of the main body may be formed to be lower than a top surface of each of the front door, a pair of the side covers, and the rear cover so as not to expose the locking part.

### CROSS-REFERENCE TO RELATED APPLICATION(S)

Pursuant to 35 U.S.C. § 119(a), this application claims the benefit of earlier filing date and right of priority to the International Application No. PCT/KR2024/006185, filed on May 8, 2024, the contents of which are all incorporated by reference herein in its entirety.

### BACKGROUND OF THE DISCLOSURE

### Field of the Disclosure

The present embodiments relate to a charging device, and more particularly, to a charging device for preventing external exposure of an eyebolt.

### Discussion of the Related Art

In general, Electric Vehicles (EVs) have not been put to practical use for a long time due to problems such as heavy weight of a battery mounted in a vehicle and a charging time of the battery and the like compared to gasoline or diesel vehicles. However, due to the recent depletion of fossil energy and environmental pollution, research and development have been actively conducted as interest in electric vehicles that do not use fossil energy and use electric energy has increased.

As a result, the spread of electric vehicles is increasing in recent years. An electric vehicle includes a battery that supplies power for driving, and has a structure in which power is stored in the battery. Therefore, in order to continuously operate the electric vehicle, the battery should be charged. Accordingly, an infrastructure for charging an electric vehicle is required, and fixedly installed standing charging facilities are being provided in various places to meet the increasing demand for electric vehicles.

In particular, a charging device of an electric vehicle provided outdoors is equipped with an eyebolt at the top to move to another place. An eyebolt is a bolt-type fixing device composed of a screw-shaped head and a long body and is used by connecting to a crane or other driving equipment, especially when moving or lifting a large object, so it is common for a charging device corresponding to a large device to have an eyebolt at the top.

Therefore, the charging device of the electric vehicle provided outdoors has a problem that the eyebolt is exposed at the upper end, resulting in a deterioration of the aesthetic design. In addition, even when the eyebolt is removed to prevent aesthetic design reduction, there is a problem that additional components for waterproofing are required and work load in the field occurs.

### SUMMARY OF THE DISCLOSURE

Accordingly, embodiments of the present disclosure are directed to a charging device that substantially obviates one or more problems due to limitations and disadvantages of the related art.

One object of the present disclosure is to provide a charging device that prevents exposure of an eyebolt in appearance by forming a step in an area where the eyebolt is installed.

Another object of the present disclosure is to provide a charging device that prevents water retention from occurring in a step by forming a water discharge passage.

Additional advantages, objects, and features of the disclosure will be set forth in the disclosure herein as well as the accompanying drawings. Such aspects may also be appreciated by those skilled in the art based on the disclosure herein.

To achieve these objects and other advantages and in accordance with the purpose of the disclosure, as embodied and broadly described herein, a charging device according to the present disclosure may include a main body having a cable connected charger located therein, a front door covering a front surface of the main body and some of both side surfaces of the main body, a pair of side covers covering the rest of the both side surfaces of the main body, a rear cover covering a rear surface of the main body, and a locking part located at a top surface of the main body, wherein the top surface of the main body may be formed to be lower than a top surface of each of the front door, a pair of the side covers, and the rear cover so as not to expose the locking part.

The top surfaces of the front door, a pair of the side covers, and the rear cover may be formed in a same plane.

A length from the top surface of the main body to the top surface of the front door, a pair of the side covers, or the rear cover may be formed greater than that of the locking part.

The charging device may further include a first space formed by the top surface of the main body and inner surfaces of the front door, a pair of the side covers, and the rear cover.

The front door may include a door part having a plate shape coupled to the front surface of the main body and a bent part extending from both sides of the door part in a direction of surrounding the both side surfaces of the main body, and the bent part may be spaced apart from the side surface of the main body.

The charging device may further include a second space formed by the door part, the bent part, and the side surface of the main body.

A top edge and side edges of both sides of the main body may form a flange of the front surface of the main body and each of the top and side edges may include a preventative projection protruding from each of the top and side surfaces of the main body.

The preventative projection may be formed of a sealing member.

The charging device may further include a support part coupled to a bottom portion of the main body and having a discharge hole in an area contacting the front door.

The discharge hole may not be exposed externally by the front door.

The charging device may further include a locking part cover having an accommodation space for accommodating the locking part therein.

A top surface of the locking part cover may form a same plane with the top surface of the side cover and a portion of a bottom surface of the locking part cover contacting the top surface of the main body may include a sealing member.

The locking part may include a fixing part located inside the main body and a ring part coupled to the fixing part and located outside the main body.

The side cover may be coupled to the main body by a fixing member and the fixing member may include a ring-shaped O-ring formed in an area where the side cover and the main body meet each other.

Accordingly, the present disclosure provides the following effects and/or advantages.

According to embodiments, there is an effect of improving the aesthetics of a charging device by providing the charging device that prevents exposure of an eyebolt by forming a step in an area where the eyebolt is installed.

According to embodiments, it is possible to prevent damage caused by moisture in a charging device by providing the charging device that prevents water retention from occurring in a step by forming a water discharge passage.

The effects obtained by the present disclosure are not limited to the above-mentioned effects, and other effects not mentioned will be clearly understood by those skilled in the art to which the present disclosure pertains from the following description

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of the present application, illustrate embodiment(s) of the disclosure and together with the description serve to explain the principle of the disclosure. The above and other aspects, features, and advantages of the present disclosure will become more apparent upon consideration of the following description of preferred embodiments, taken in conjunction with the accompanying drawing figures. In the drawings:

FIG. 1 is a diagram illustrating a charging device according to embodiments;

FIG. 2 is an exploded diagram illustrating a charging device according to embodiments;

FIG. 3 and FIG. 4 are diagrams illustrating a first space of a charging device according to embodiments;

FIG. 5 and FIG. 6 are diagrams illustrating a second space of a charging device according to embodiments.

FIG. 7 is a diagram illustrating a path on which water moves along a first space and a second space of a charging device according to embodiments;

FIG. 8 is a diagram illustrating a lower portion of a charging device according to embodiments;

FIG. 9 is a diagram illustrating a locking part cover of a charging device according to embodiments; and

FIG. 10 is a diagram illustrating a coupled state of a side cover of a charging device according to embodiments.

### DETAILED DESCRIPTION OF THE DISCLOSURE

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

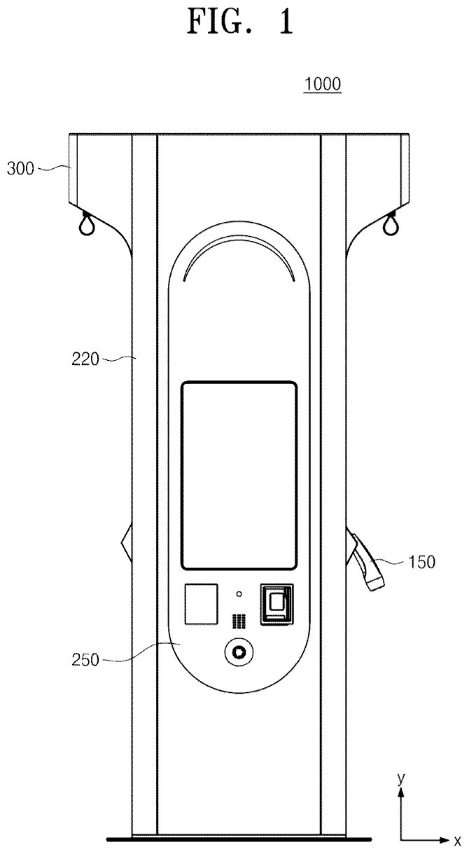

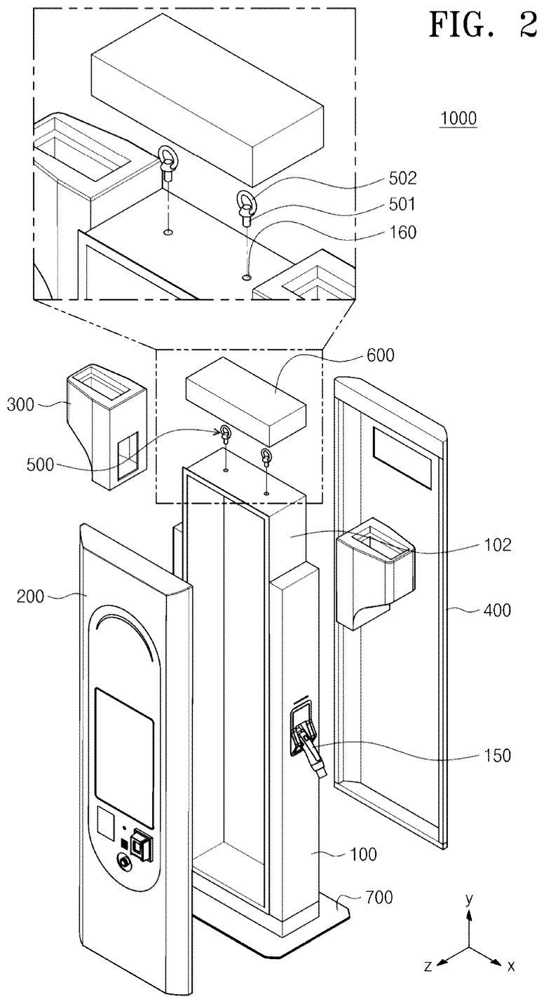

FIG. 1 is a diagram illustrating a charging device according to embodiments. FIG. 2 is an exploded diagram illustrating a charging device according to embodiments.

A charging device 1000 shown in FIG. 2 corresponds to a charging device 1000 shown in FIG. 1.

Hereinafter, in describing the charging device 1000 according to the embodiments, a horizontal direction is described based on an x-axis direction, a vertical direction is described based on a y-axis direction, and a direction toward a front surface and a rear surface is described based on a z-axis direction.

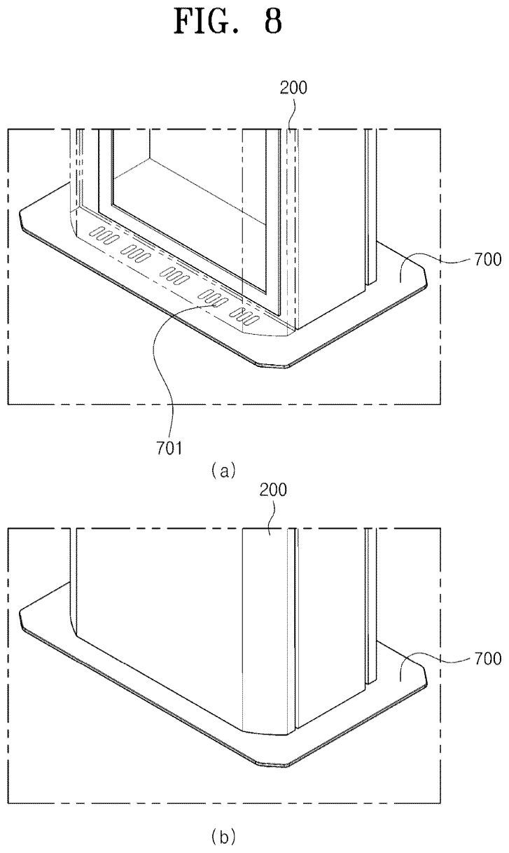

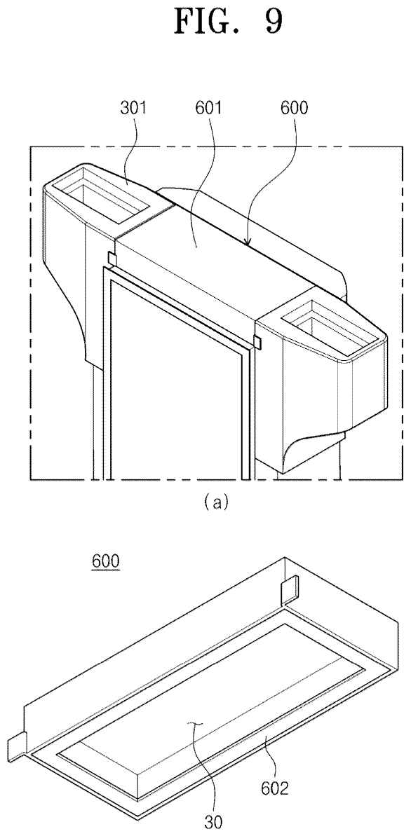

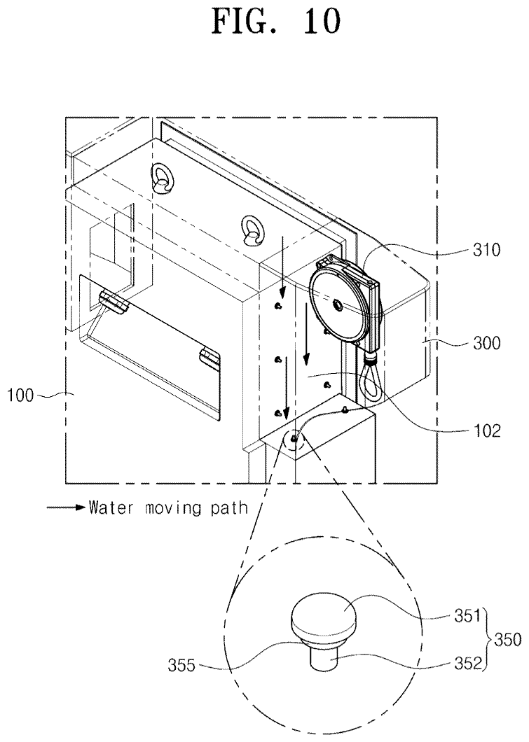

Referring to FIG. 1 and FIG. 2, a charging device 1000 according to embodiments may include a main body 100, a front door 200, a side cover 300, a rear cover 400, a locking part 500, a locking part cover 600, a support part 700, and the like. The locking part cover 600 will be described in FIG. 8, and the support part 700 will be described in FIG. 9.

The charging device 1000 according to the embodiments may be a type of device for charging an Electric Vehicle (EV). More specifically, the charging device 1000 according to the embodiments may correspond to an EV charger dispenser, which is one of devices used when charging the electric vehicle. A dispenser is a device that stores and protects a charging cable, and is generally installed in combination with a charger, and a user may pull the cable connected to the charger from the dispenser and connect the cable to the electric vehicle.

A charger 150 to which a cable is connected is positioned in the main body 100, and an LED indicator or screen indicating a charging state may be built in the main body 100. As illustrated in FIG. 1 and FIG. 2, the main body 100 may have a rectangular parallelepiped shape, and the front door 200, the side cover 300, and the rear cover 400 may cover a circumference thereof.

The front door 200 is configured to cover a front surface and a portion of a side surface 102 of the main body 100, and may display an LED indicator, a screen, or the like indicating a charging state. The rear cover 400 is configured to cover a rear surface of the main body 100.

The side cover 300 is configured to cover the rest of the side surface 102 of the main body 100, and may be provided in a pair on both sides of the main body 100. A retractor 310 (see FIG. 10) may be positioned within the side cover 300. The retractor 310 is a device that safely stores a charging cable and helps a user to use it conveniently, and the side cover 300 that stores the retractor 310 may cover an upper part of the side surface 102 of the main body 100 as shown in FIG. 1 and FIG. 2. A coupling relationship between the side cover 300 and the main body 100 will be described with reference to FIG. 10.

The locking part 500 is located on a top surface of the main body 100 and may include a fixing part 501 and a ring part 502. The fixing part 501 may be located inside the main body 100. More specifically, the fixing part 501 may be inserted into and fixed/coupled to a receiving recess 160 formed on the top surface of the main body 100. The ring part 502 may be coupled to the fixing part 501 and located outside the main body 100. That is, the fixing part 501 may be inserted into the top surface of the main body 100 to be located inside the main body 100, and the ring part 502 may be located outside the main body 100.

The charging device 1000 according to the embodiments may be moved through the locking part 500. That is, the charging device 1000 may be moved to another place by hanging a string, a rope, or the like on the ring part 502 of the locking part 500. The locking part 500 may be a type of eyebolt.

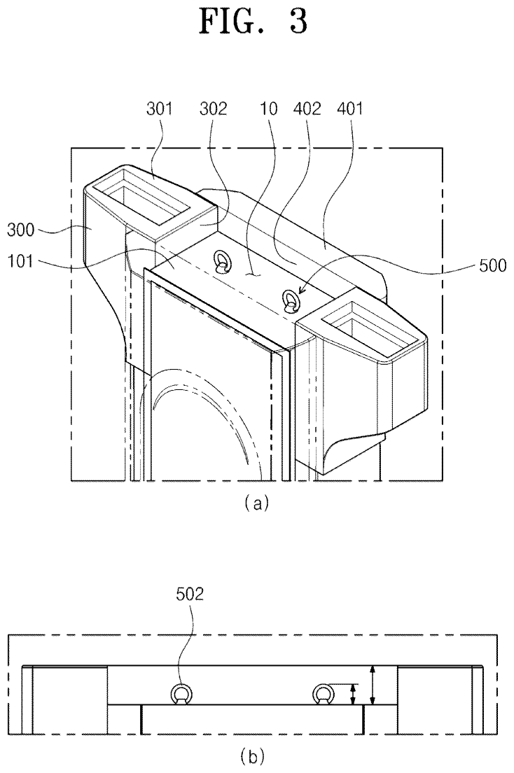

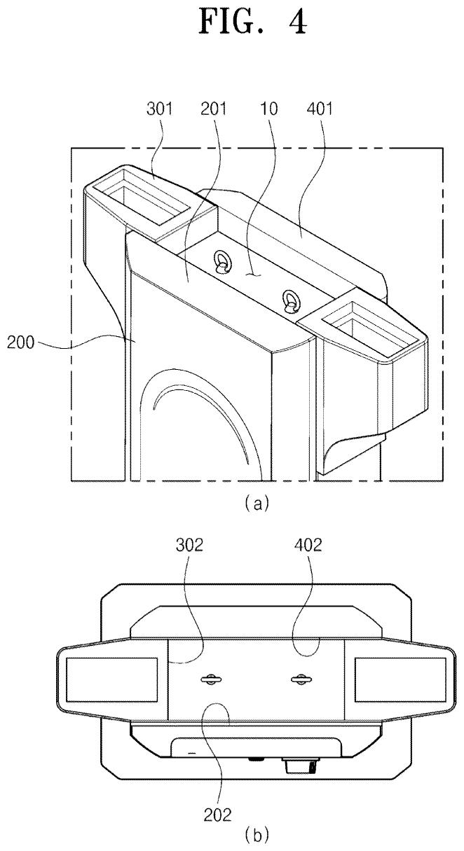

The charging device of the related art has the problem in that the locking part 500 is exposed to the outside, and thus the design thereof is deteriorated in appearance. Accordingly, in the charging device 1000 according to the embodiments, the top surface of the main body 100 may be formed to be lower than a top surface of the front door 200, the side cover 300, and/or the rear cover 400 so that the locking part 500 is not exposed to the outside. A detailed description thereof will be described with reference to FIG. 3 and FIG. 4.

FIG. 3 and FIG. 4 are diagrams illustrating a first space of a charging device according to embodiments. More specifically, FIG. 3 is a view illustrating a first space in a state in which a front door of a charging device is excluded according to embodiments, and FIG. 4 is a diagram illustrating a first space in a state in which a front door of a charging device is coupled according to embodiments.

A side cover 300 shown in FIG. 3 corresponds to the side cover 300 shown in FIG. 1 and FIG. 2. A locking part 500 shown in FIG. 3 corresponds to the locking part 500 shown in FIG. 2. FIG. 4 is a diagram illustrating that a front door 200 is added in FIG. 3.

Referring to FIG. 3 and FIG. 4, a top surface 101 of the main body 100 may be formed to be lower than a top surface 202 of the front door 200, a top surface 301 of the side cover 300, and/or a top surface 401 of the rear cover 400. In other words, the main body 100 may be positioned such that a step is formed from each of the front door 200, the side cover 300, and/or the rear cover 400.

The top surface 202 of the front door 200, the top surface 301 of the side cover 300, and the top surface 401 of the rear cover 400 may be formed in the same plane. In other words, the top surface 201 of the front door 200, the top surface 301 of the side cover 300, and the top surface 401 of the rear cover 400 may form one plane, i.e., have the same height.

In addition, a length from the top surface 101 of the main body 100 to the top surface 201 of the front door 200, a length from the top surface 101 of the main body 100 to the top surface 301 of the side cover 300, and a length from the top surface 101 of the main body 100 to the top surface 401 of the rear cover 400 may be formed greater than a length of the locking part 500. More specifically, as shown in FIG. 3 (b), the length from the top surface 101 of the main body 100 to the top surface 201 of the front door 200, the length from the top surface 101 of the main body 100 to the top surface 301 of the side cover 300, and the length from the top surface 101 of the main body 100 to the top surface 401 of the rear cover 400 may be formed greater than a length of the ring part 502.

Accordingly, the locking part 500 of the charging device 1000 according to the embodiments may not be exposed to the outside by being located in a first space 10 formed by the front door 200, the side cover 300, and the rear cover 400.

More specifically, the first space 10 may be formed by the top surface 101 of the main body 100, an inner surface 202 of the front door 200, inner surfaces 302 of a pair of the side covers 300, and an inner surface 402 of the rear cover 400. That is, the locking part 500, more specifically, the ring part 502 may be located in the first space 10 having a rectangular parallelepiped shape. Since four surfaces of the first space 10 are formed by the front door 200, the side cover 300, and the rear cover 400, the locking part 500 may not be exposed to the outside through the four surfaces as a result.

Accordingly, there is an effect that the locking part 500 of the charging device 1000 according to the embodiments is not exposed to a user.

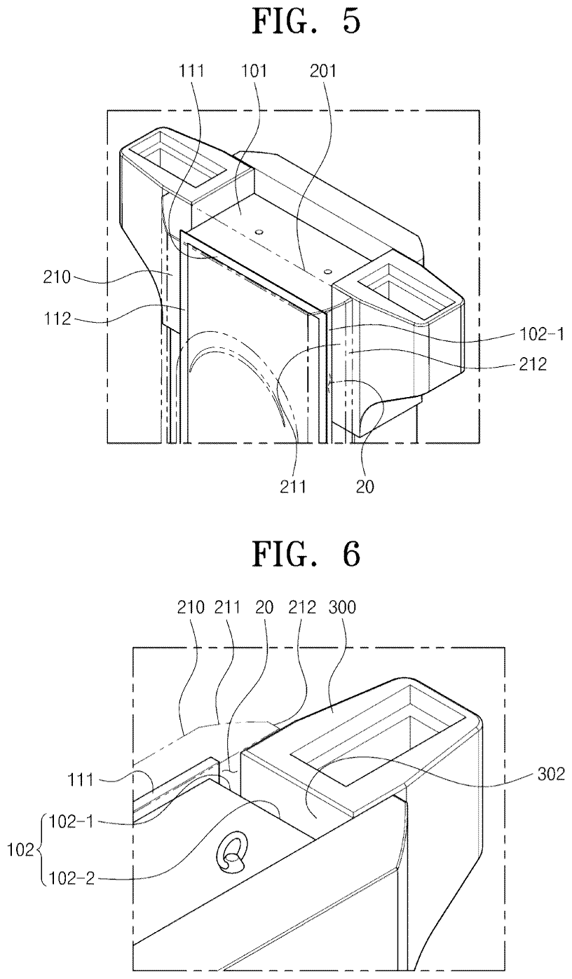

FIG. 5 and FIG. 6 are diagrams illustrating a second space of a charging device according to embodiments. More specifically, FIG. 5 is a diagram illustrating a second space of a charging device according to embodiments viewed from a front direction, and FIG. 6 is a diagram illustrating a second space of a charging device according to embodiments viewed from a rear direction.

FIG. 5 is a diagram illustrating that the locking part 500 is excluded from FIG. 3 (a). FIG. 6 is another diagram of FIG. 5 as viewed from a rear direction.

Referring to FIG. 5 and FIG. 6, the front door 200 may include a door part 210, an inclined part 211, and a bent part 212.

The door part 210 may be formed in a plate shape coupled to a front surface of the main body 100. The top surface 201 of the door part 210 may correspond to the top surface 201 of the front door 200.

The bent part 212 may be formed to extend from both sides of the door part 210 in a direction surrounding portions of both side surfaces 102 of the main body 100. According to embodiments, the inclined part 211 having a predetermined inclination may be formed between the bent part 212 and the door part 210.

The side surface 102 of the main body 100 may include a first side surface 102-1 covered by the bent part 212 and a second side surface 102-2 covered by the side cover 300. In this case, the bent part 212 may be formed to be spaced apart from the first side surface 102-1 by a predetermined distance, and the side cover 300 may be formed such that an inner side surface 302 thereof contacts the second side surface 102-2.

In addition, the bent part 212 is formed to be spaced apart from the first side surface 102-1 by a predetermined distance, thereby forming a second space 20. That is, the second space 20 may be formed by the door part 210, the inclined part 211, the bent part 212, and the first side surface 102-1 of the main body 100.

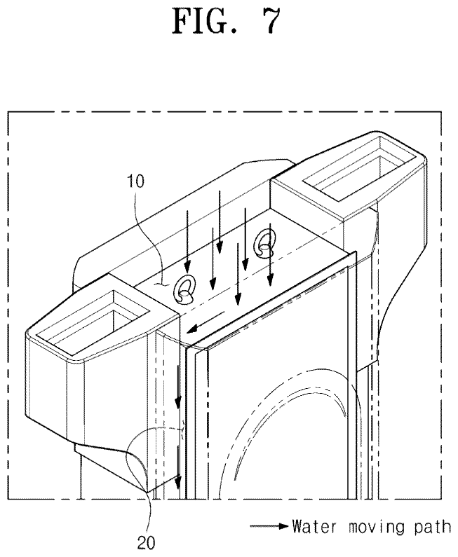

Also, the top surface 201 of the door part 210 may be formed to be spaced apart from the top surface 101 of the main body 100 by a predetermined distance. Accordingly, the first space 10 formed by the top surface 101 of the main body 100 (refer to FIG. 3 and FIG. 4) and the second space 20 formed by the first side surface 102-1 of the main body 100 may be connected to each other. Moisture and the like present in the first space 10 may be discharged through the second space 20. A detailed description thereof will be described with reference to FIG. 7.

Referring to FIG. 3, a front surface of the main body 100 may include an upper edge and a side edge that form a flange. In other words, the upper edge may be located on an upper portion of the front flange of the main body 100, and the side edge may be located on both sides of the front flange of the main body.

The upper edge and the side edge may be formed with preventive projections 111 and 112 protruding at a predetermined height from the top surface 101 of the main body 100 and the side surface 102 of the main body 100, respectively. That is, the upper edge may include an upper preventive projection 111 protruding at a predetermined height in an upward direction with respect to the top surface 101 of the main body 100. And the side edge may include a side preventive projection 112 protruding at a predetermined height in a left or right direction with respect to the side surface 102 of the main body 100.

Also, the preventive projections 111 and 112 may be formed of a sealing member. That is, the preventive projections 111 and 112 may include a sealing member formed along the preventive projections 111 and 112, or may be formed of a sealing member.

FIG. 7 is a diagram illustrating a path along which water moves through a first space and a second space of a charging device according to embodiments.

A first space 10 illustrated in FIG. 7 corresponds to the first space 10 illustrated in FIG. 3 and FIG. 4. A second space 20 illustrated in FIG. 7 corresponds to the second space 20 illustrated in FIG. 5 and FIG. 6. And, FIG. 7 is a diagram of the charging device illustrated in FIG. 3, 5 or 6, viewed from the front direction.

Referring to FIG. 7, water having accumulated in the first space 10 due to rain or snow may move through the second space 20 connected to the first space 10 without continuously accumulating in the first space 10.

As described in FIG. 1 and FIG. 2, the charging device 1000 according to the embodiments may be a type of an electric vehicle charger, and particularly, may be a type of a charger dispenser provided outdoors. As described above, in the charging device 1000 according to the embodiments, the top surface 101 of the main body 100 may be formed to be lower than the top surface 201 of the front door 200, the top surface 301 of the side cover 300, and the top surface 401 of the rear cover 400 in order to prevent the locking part 500 from being exposed to the outside. That is, the locking part 500 of the charging device 1000 according to the embodiments may be located in the first space 10 with an open upper portion. As a result, water may accumulate in the first space 10 when it snows or rains since the charging device 1000 is provided outdoors.

Accordingly, the charging device 1000 according to the embodiments may form the second space 20 connected to the first space 10 to prevent water from accumulating in the first space 10. A description of the second space 20 is the same as that described in FIG. 5 and FIG. 6, and thus will be omitted.

Namely, referring to FIG. 7, the water having accumulate in the first space 10 moves downward along the second space 20 formed by the side surface 102 of the main body 100. Therefore, even in a situation where it rains or snows a lot, water fails to accumulate in the first space 10 where the locking part 500 of the charging device 1000 is located according to the embodiments.

In addition, as described in FIG. 5 and FIG. 6, the upper edge and the side edge of the main body 100 may be formed with the preventive projections 111 and 112 made of sealing members, respectively. Therefore, the charging device 1000 according to the embodiments may prevent moisture damage to the main body 100 and the front door 200, even when water moves along the first space 10 and the second space 20, owing to the preventive projections 111 and 112.

Accordingly, the charging device 1000 according to the embodiments does not expose the locking part 500 to the outside but also prevents damage caused by moisture.

FIG. 8 is a diagram illustrating a lower portion of a charging device according to embodiments. More specifically, FIG. 8 (a) is a diagram illustrating a lower portion of a charging device excluding a front door according to embodiments, and FIG. 8 (b) is a diagram illustrating a lower portion of a charging device in a state where a front door of a charging device is coupled thereto according to embodiments.

A front door 200 illustrated in FIG. 8 corresponds to the front door 200 illustrated in FIG. 1 and FIG. 2. A support part 700 illustrated in FIG. 8 corresponds to the support part 700 illustrated in FIG. 2.

Referring to FIG. 2 and FIG. 8 together, the support part 700 is coupled to a lower portion of the main body 100 and fixes the main body 100 to the ground, and a discharge hole 701 may be formed in an area that contacts the front door 200. A plurality of discharge holes 701 may be formed, as shown in FIG. 8 (a). More specifically, the discharge hole 701 may be connected to the second space 20 formed by the front door 200 and the side surface 102 of the main body 100.

Namely, as described in FIG. 7, the water having accumulated in the first space 10 moves downward through the second space 20. And as a result, the water may be collected in an inside of the front door 200, i.e., in a lower portion of a space formed by the door part 210, the bent part 212, and the side surface 102. Accordingly, the charging device 1000 according to the embodiments may discharge the water collected in the lower portion to the outside through the discharge hole 701.

Referring to FIG. 8, the discharge hole 701 may not be exposed to the outside by the front door 200. That is, the discharge hole 701 may be formed in an area of the support part 700 that is in contact with a bottom surface of the front door 200. Therefore, the discharge hole 701 may not be exposed to the outside by the appearance of the door part 210, the inclined part 211, and the bent part 212 of the front door 200.

FIG. 9 is a diagram illustrating a locking part cover of a charging device according to embodiments. More specifically, FIG. 9 (a) is a diagram illustrating a state in which the locking part cover of the charging device is coupled to a main body according to embodiments, and FIG. 9 (b) is a diagram illustrating a lower portion of the locking part cover of the charging device according to embodiments.

A locking part cover 600 illustrated in FIG. 9 corresponds to the locking part cover 600 illustrated in FIG. 2.

Referring to FIG. 2 and FIG. 9 together, the locking part cover 600 has an accommodation space 30 for accommodating the locking part 500, and may be coupled to the side cover 300 to cover the top surface 101 of the main body 100. That is, the locking part cover 600 may prevent the locking part 500 from being exposed to the outside not only in four surface directions but also in a top surface direction. The locking part cover 600 may be detachable.

A top surface 601 of the locking part cover 600 may form the same plane as the top surface 301 of the side cover 300. That is, as shown in FIG. 9 (a), the height of the locking part cover 600 may be formed to be equal to a distance from the top surface 101 of the main body 101 to the top surface 301 of the side cover 300.

A bottom surface of the locking part cover 600 may include a sealing member 602 as illustrated in FIG. 9 (b). More specifically, a portion of the bottom surface of the locking part cover 600, which meets the top surface 101 of the main body 100, may include the sealing member 602.

Accordingly, the charging device 1000 according to the embodiments has the effect of improving the appearance aesthetics through the locking part cover 600. Also, the charging device 1000 according to the embodiments has the effect that the locking part cover 600 completely blocks the first space 10 in which the locking part 500 is located, and in particular, the sealing member 602 is formed on the bottom surface, thereby completely controlling the access to the first space 10.

FIG. 10 is a diagram illustrating a coupled state of a side cover of a charging device according to embodiments.

A main body 100 illustrated in FIG. 10 corresponds to the main body 100 illustrated in FIG. 2. A side cover 300 illustrated in FIG. 10 corresponds to the side cover 300 illustrated in FIG. 1 and FIG. 2.

Referring to FIG. 2 and FIG. 10 together, the side cover 300 may be coupled to the main body 100 by a fixing member 350. More specifically, the side cover 300 may be coupled to the second side surface 102-2 (see FIG. 5 and FIG. 6) of the side surface 102 of the main body 100 by the fixing member 350.

The fixing member 350 may include a first fixing part 351 having a disk shape and a second fixing part 352 extending from one surface of the first fixing part 351. Referring to FIG. 10, the first fixing part 351 may be fixed to the inside of the main body 100, and the second fixing part 352 may be fixed to the inside of the side cover 300, which is only an example. Alternatively, the first fixing part 351 may be fixed to the inside of the side cover 300, and the second fixing part 352 may be fixed to the inside of the main body 100.

The fixing member 350 may include an O-ring 355 having a ring shape formed in an area where the side cover 300 meets the main body 100. That is, the O-ring 355 may be positioned in an area where the first fixing part 351 meets the second fixing part 352.

As described in FIG. 7, water may accumulate in the first space 10 in situations such as snow or rain, and the water having accumulated in the first space 10 may move to the second space 20.

In doing so, the water having accumulated in the first space 10 may penetrate not only the second space 20 but also a space between the side surface 102 of the main body 100 and the side cover 300 coupled to the side surface 102.

Accordingly, the O-ring 355 of the fixing member 350 of the charging device 1000 according to the embodiments is located in an area where the side cover 300 and the main body 100 meet each other, thereby preventing moisture from moving into the main body 100 and the side cover 300.

The detailed description of the preferred embodiments of the present disclosure disclosed as described above has been provided to allow those skilled in the art to embody and implement the present disclosure. Although the above has been described with reference to the preferred embodiments of the present disclosure, those skilled in the art will understand that the present disclosure may be variously modified and changed without departing from the scope of the present disclosure. For example, those skilled in the art may use each of the components described in the above-described embodiments in a manner of combining them with each other.

Therefore, the present disclosure is not intended to be limited to the embodiments shown here, but to give a maximum scope consistent with the principles and new features disclosed herein.

What is claimed is:

1. A charging device, comprising:
a main body having a cable connected charger located therein;
a front door covering a front surface of the main body and some of both side surfaces of the main body;
a pair of side covers covering the rest of the both side surfaces of the main body;
a rear cover covering a rear surface of the main body; and
a locking part located at a top surface of the main body,
wherein the top surface of the main body is formed to be lower than a top surface of each of the front door, a top surface of the pair of the side covers, and a top surface of the rear cover so as not to expose the locking part.

2. The charging device of claim 1, wherein the top surface of the front door, the top surface of the pair of the side covers, and the top surface of the rear cover are formed in a same plane.

3. The charging device of claim 1, wherein a length from the top surface of the main body to the top surface of the front door, a length from the top surface of the main body to the pair of the side covers, or a length from the top surface of the main body to the rear cover is formed greater than that of the locking part.

4. The charging device of claim 1, further comprising a first space formed by the top surface of the main body and inner surfaces of the front door, the pair of the side covers, and the rear cover.

5. The charging device of claim 1, the front door comprising:
a door part having a plate shape coupled to the front surface of the main body; and
a bent part extending from both sides of the door part in a direction of surrounding the both side surfaces of the main body,
wherein the bent part is spaced apart from the side surface of the main body.

6. The charging device of claim 5, further comprising a second space formed by the door part, the bent part, and the side surface of the main body.

7. The charging device of claim 1, wherein a top edge and side edges of both sides of the main body form a flange of the front surface of the main body and wherein each of the top edge and the side edges includes a preventative projection protruding from each of the top and side surfaces of the main body.

8. The charging device of claim 7, wherein the preventative projection is formed of a sealing member.

9. The charging device of claim 1, further comprising a support part coupled to a bottom portion of the main body and having a discharge hole in an area contacting the front door.

10. The charging device of claim 9, wherein the discharge hole is not exposed externally by the front door.

11. The charging device of claim 1, further comprising a locking part cover having an accommodation space for accommodating the locking part therein.

12. The charging device of claim 11, wherein a top surface of the locking part cover forms a same plane with the top surface of the side cover and wherein a portion of a bottom surface of the locking part cover contacting the top surface of the main body includes a sealing member.

13. The charging device of claim 1, the locking part comprising:
a fixing part located inside the main body; and
a ring part coupled to the fixing part and located outside the main body.

14. The charging device of claim 1, wherein the side cover is coupled to the main body by a fixing member and wherein the fixing member includes a ring-shaped O-ring formed in an area where the side cover and the main body meet each other.
